(19) United States
(12) Patent Application Publication
(10) Pub. No.: US 2004/0131215 A1
(43) Pub. Date: Jul. 8, 2004

(54) Fluid diverter for hearing aids

(76) Inventor: Lawrence K. Baker, Gate City, VA (US)

Correspondence Address: Michael Y. Epstein, Suite H, 387 King St., Charleston, SC, 29403, US

(21) Appl. No.: 10/680,308

(22) Filed: Oct. 7, 2003

Related U.S. Application Data
(63) Continuation-in-part of application No. 10/119,160, filed on Apr. 9, 2002, now Pat. No. 6,738,488.
Application No. 10/119,160 is a continuation-in-part of application No. 09/864,416, filed on May 25, 2001, now Pat. No. 6,449,373.
(60) Provisional application No. 60/416,687, filed on Oct. 7, 2002.

(51) Int. Cl. H04R 25/00

(52) U.S. Cl. 381/325; 381/312

(57) ABSTRACT

For providing protection against penetration of fluid-like substances within the ear canal of a hearing aid user into the hearing aid sound port, a hood-like member is utilized in surrounding relation with the sound port for providing paths for the fluid-like substances past and spaced apart from the sound port. The hood-like member is disposed at the end of a hollow stem which provides means for mounting the hood-like members on the hearing aid; the stem either being inserted into the hearing aid sound port, or the hearing aid output sound tube extending into the hollow stem.

This application is a continuation-in-part of co-pending application Ser. No. 10/119,160, filed Apr. 9, 2002; which co-pending application was a continuation-in-part of application Ser. No. 09/864,416 filed May 25, 2001, now U.S. Pat. No. 6,449,373. This application also claims the benefit of provisional application 60/416,687, filed Oct. 7, 2002.

This invention relates to hearing aids and discloses inventive embodiments which are variations of the embodiments shown in my aforecited patent and patent application, the subject matter of both documents being incorporated herein by reference.

### BACKGROUND OF THE INVENTION

As disclosed in the patent and the application, hood-like members are disposed adjacent to the sound port of a hearing aid for diverting, under the influence of gravity, fluid-like substances within a user's ear canal downwardly past, and spaced away, from the sound port. By “fluid-like substances” is meant various mixtures of ear secretions and water entering the ear during washing and the like. The embodiments disclosed herein make use of hood-like members similar to those disclosed in the patent and the application, but include a stem-like structure for mounting the hood-like members on hearing aids.

### SUMMARY OF THE INVENTION

For mounting hood-like members of the type described in my earlier patent and pending patent application on hearing aid sound plugs inserted into the ear canal of a user, the hood-like member is disposed at the end of a hollow stem designed for mating with the sound output port of the sound plug. The hood-like member can be a separate part mounted on an end of the stem, or the hood-like member can be an integral shaped end of the stem.

### DESCRIPTION OF THE DRAWING

All the drawing figures show a hood-like member at an end of a hollow stem designed to mate with the sound output tube of a hearing aid in-canal ear plug.

FIG. 1 shows, in section, the front end of a hearing aid and a stem assembly according to the present invention mounted thereon;

FIG. 2 is a view, looking to the left, of FIG. 1;

FIG. 3 is a view similar to that of FIG. 2 but showing a modification of the hood-like member mounted on the stem;

FIGS. 4 and 5 are views similar to that of FIG. 1 but showing a smaller portion, and modifications, of the assembly shown in FIG. 1; and

FIGS. 6-13 show, schematically, various stem assemblies including, on an end of the stems, various hood-like members effective for diverting fluid-like substances downwardly past the sound ports of the stems.

### DESCRIPTION OF PREFERRED EMBODIMENTS

FIGS. 1 and 2 show a side section and front view, respectively, of a hearing aid 10 comprising a plastic envelope 12 enclosing a receiver 14 including a sound tube 16 terminating generally flush with the envelope front surface 20.

FIGS. 1 and 2 additionally show a hood-like member 30 somewhat similar to the member 12 shown in FIG. 1 of the aforecited patent and to the member 50 shown in FIG. 5 of the application, but differing in the manner of mounting the hood-like member 30 in place.

As shown herein, the hood-like member 30 is mounted on the end of a short, hollow stem 32 dimensioned to fit snugly within the sound tube 16. In this embodiment, the forward end of the stem is surrounded by an annular (washer-like) plate 38 preferably firmly engaged with the end surface 20 of the hearing aid envelope. The hood-like member 30 is mounted on the plate (e.g., is integral with it) for completely enclosing the opening 40 through the plate 38 (and through the stem 32) except for a small downwardly facing opening 42 providing an exit for sound from the sound tube 16 and the stem 32. The member 30 has an awning-like shape including a continuous wall 44 having a front wall portion 44a and side wall portions 44b extending downwardly from a line 45 above the plate opening 40, and along lines 45a on either side of the opening, past and below the opening 40.

When the hearing aid 10 is inserted into the ear canal of a user, the opening 42 faces directly downwardly towards the floor of the ear canal and the only path for entry of fluid-like substances within the ear canal into the hearing aid is directly upwardly against the force of gravity. Basically, the hood-like member 30 provides a gravity assisted path for fluid-like substances downwardly past and spaced away from the sound tube 16 leading to the receiver 14.

In the embodiment shown in FIGS. 1 and 2, the front and side portions of wall 44 of the hood-like member 30 are impervious to fluids from the top 45 of the member to a line 46 below the bottom edge of the opening 40 through the stem.

From the bottom edge 46 of the impervious portion of the wall 44, the front portion 44a of the wall is continued by a wire mesh 50 which extends downwardly and is angled towards the envelope surface 20 until the mesh 50 comes into contact with the plate 38 to which it is sealed. The side portions 44b of the member 30 below the edge 46 are optionally also a mesh or an impervious continuation of the upper side portions 44b. The mesh 50 provides an exit for sound in a generally forward direction towards the user's ear drum while, similarly as the mesh 48 shown in FIG. 1 of the patent, provides a downward path for fluid-like substances contacting (and even penetrating) the mesh. The parameters of the mesh 48, as well as those of other meshes described herein, can be in accordance with the mesh parameters provided in my aforecited patent.

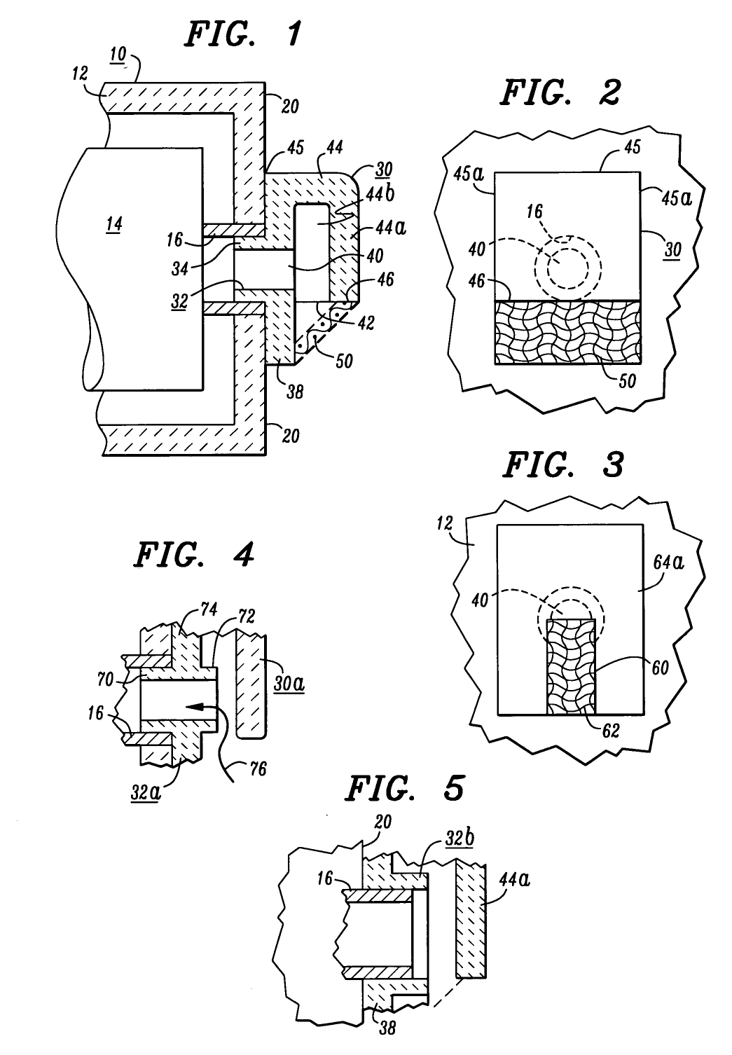

In FIG. 3, the member front and side wall portions are impervious from top to bottom, but the front wall portion 64a includes a vertical slit 60 extending from a point generally opposite the center of the stem opening 40 to the bottom of the wall 64a. The slit 60 has a width generally corresponding to the diameter of the stem opening 40 (e.g., around 0.040 inch) and is covered with a wire mesh 62. The mesh covered slit 60 provides an exit for sound directly towards the user's ear drum while also diverting fluid-like substances downwardly past, and spaced away from, the stem opening. The correspondence between the width of the slit 60 and the diameter of the opening 40 avoids any distortion of the exiting sound signal.

In FIG. 4, a stem 32a includes a portion 72 extending entirely through an annular plate 74 and protruding slightly inwardly of the interior of an enclosing hood member 30a. While the gravity utilizing orientation of the member 30a prevents entry of fluid-like substances inwardly of the member 30a, backup protection against any such penetration directly into the sound tube 16 (and thence to the hearing aid receiver) is provided by the extending portion 72 of the stem 70. That is, substances moving upwardly along a path 76 into the member 30a must follow a return-bent path to enter the stem portion 72.

FIG. 5 shows a stem 32b similar to the stem 32a shown in FIG. 4 but excluding any portions extending into the hearing aid sound tube 16. Rather, the sound tube 16 extends into the stem 32b.

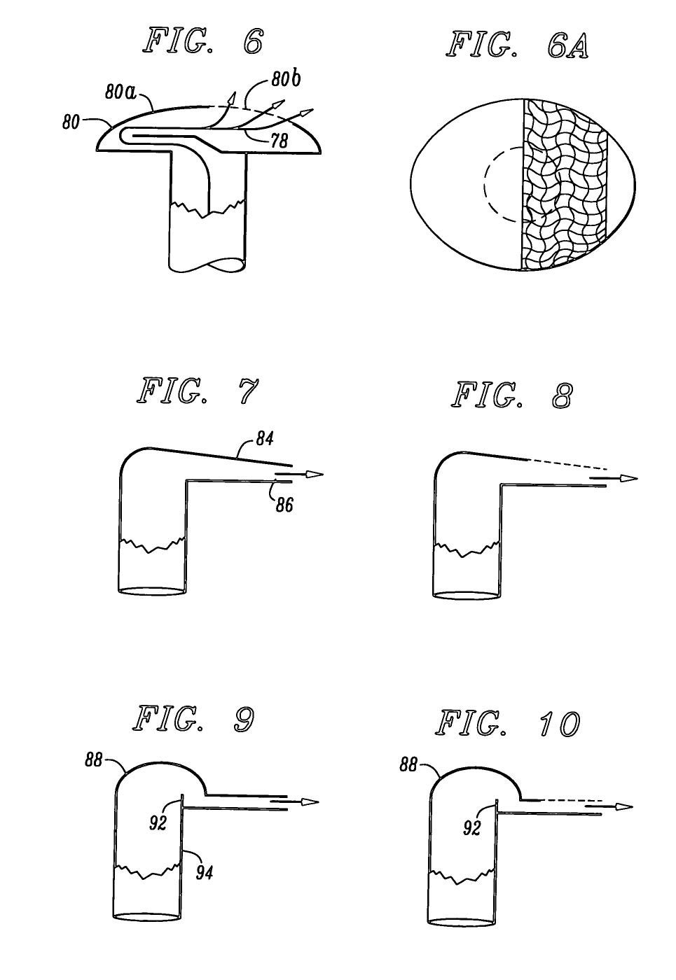

FIGS. 6 and 6A through 14 are schematic illustrations of other embodiments of the invention. In these figures, the illustrated components are not to scale. In particular, the hood-like members are shown quite large in the horizontal dimension. In preferred embodiments the entire horizontal dimension of the hood-like member is very small, e.g., less than 0.040 inch, and a major advantage of the invention is the economy of space in its use.

In FIG. 6, the hood-like member has an internal return-bent path 78 for sound similar to that shown in FIG. 7 of the patent. The fluid-like substance diverting portion 80 of the stem assembly has a generally dome-like shape including a portion 80a which is impervious to fluids and a mesh portion 80b providing a sound port for sound while still providing a downward directed diversionary path for fluid-like substances. The mesh portion 86 sound port can be washed with a solvent for removing ear wax accumulated on the mesh.

FIG. 6A shows a front view of the stem assembly shown in FIG. 6. In FIG. 6, as well as in FIGS. 7-14, the downward direction, when the stem assemblies are inserted into a user's ear canal, is to the right. Thus, when in use, fluid-like substances in a user's ear canal contacting the portion 80 of the assembly shown in FIG. 6 tend to flow, under the force of gravity, to the right towards the floor of the ear canal.

In FIGS. 7 and 8, the stems do not extend into enclosing hood-like members as in, for example, FIG. 5, but the stein is itself shaped to provide a downward path for in-canal fluids. In FIG. 7, a downwardly bent stem portion 84 has impervious walls with a single sound port 86. In FIG. 8, part of the downwardly pointing portion of the stem is made of a sound pervious mesh.

In FIGS. 9 and 10 a dome-like structure 88 is added at the end of the stem pointing towards the eardrum. An extension 92 of the lower side wall 94 of the stem into the dome 88 provides a return-bent path of increased length for in-flowing fluids.

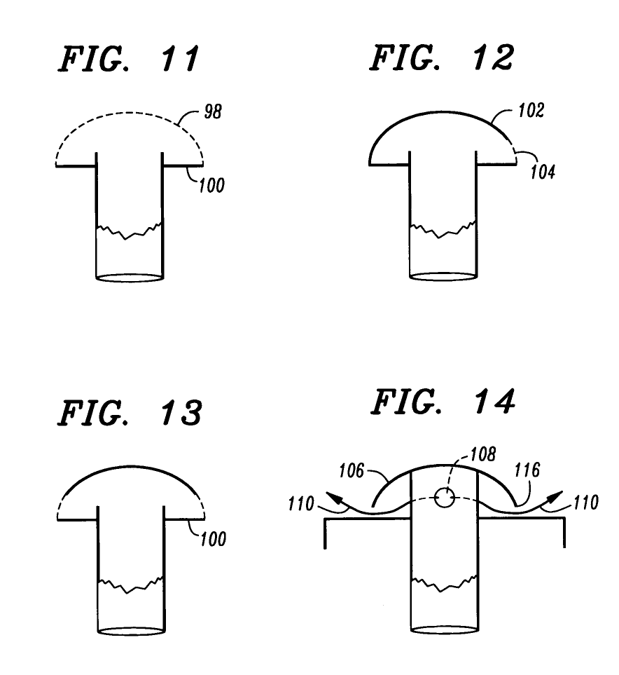

In FIGS. 11-14, stems extend directly into dome-like structures similarly as in 4. In FIG. 11, the dome is formed wholly from a mesh 98 secured to a washer-like portion 100 of the stem.

In FIG. 12, the dome is of an impervious material and includes a downwardly facing opening 102 covered with a mesh 104.

In FIG. 13, the mesh shown in FIG. 12 extends entirely around the periphery of the dome and interconnects the dome to the stem plate 100. In use, no orientation of the assembly relative to the down direction is required.

In FIG. 14, the stem is wholly capped by an impervious dome 106. Sound exits one or more holes 108 through the side wall of the stem for exiting along paths 110 extending beneath the dome edge 116.

What is claimed is:

1. An assembly for use with a hearing aid plug for insertion into the ear canal of a user and having a sound port in a front surface of the plug facing towards the user's ear drum when so inserted, the assembly comprising a stem for being engaged with the sound port for mounting the assembly on the hearing aid, said stem being hollow and providing, when mounted on the hearing aid, a hearing aid second sound port disposed inwardly of a structure providing diversionary paths for fluid-like substances within the ear canal in directions past and spaced apart from said second sound port.
